(19) United States
(12) Patent Application Publication
(10) Pub. No.: US 2020/0364232 A1
(43) Pub. Date: Nov. 19, 2020

(54) SEARCH ASSISTANCE FOR GUESTS AND MEMBERS

(71) Applicant: Microsoft Technology Licensing, LLC, Redmond, WA (US)

(72) Inventors: Swanand Wakankar, Campbell, CA (US); Anand Sivaramakrishnan, Morgan Hill, CA (US); Raveesh Bhalla, San Francisco, CA (US); Ahsan Latif Chudhary, Milpitas, CA (US); Nagaraj Kota, Bangalore (IN); Nitin Panjwani, Los Altos, CA (US)

(21) Appl. No.: 16/411,337

(22) Filed: May 14, 2019

(51) Int. Cl. G06F 16/2457; G06F 16/9535; G06F 16/9538; G06N 20/00; G06Q 10/10

(52) U.S. Cl. CPC G06F 16/24578; G06F 16/9535; G06Q 10/1053; G06N 20/00; G06F 16/9538

(57) ABSTRACT

Methods, systems, and computer programs are presented for improving search mechanisms for guest users or unidentified members of an online service. One method includes operations for detecting a first search query for a guest user and for initializing a session for the guest user in response to the first search query. Further, the method includes operations for logging activities of the guest user during the session and detecting a second search query on the online service for the guest user while the session is active. Results are obtained in response to the second search query, and the results are prioritized based on the second search query and the activities logged of the guest user. Further, the plurality of results is presented on a computing device of the guest user.

### TECHNICAL FIELD

The subject matter disclosed herein generally relates to methods, systems, and machine-readable storage media for improving search results and, more particularly, for assisting guest users or members of an online service that have not logged in but that are performing searches on the online service.

### BACKGROUND

Searching can be a daunting task when the search results may include thousands or millions of possibilities. In particular, a job search may be an arduous task when the number of job openings that match a search query is very large. The user may have to keep adding filters in order to arrive at the desired job openings.

Some search systems assist the user by considering the characteristics of the user when performing a search. For example, if the user enters a query for software developer, the search engine may take into consideration some of the characteristics of the user to rank the results, such as experience, location, whether the user is looking for a large or small company, the user's connections, etc.

However, when the online service providing the search capabilities does not have information about the user (e.g., the user is a guest user or is a member that has not logged into the service), the online service is not able to enhance the user experience by making the search task easier based on the user characteristics.

### BRIEF DESCRIPTION OF THE DRAWINGS

Various ones of the appended drawings merely illustrate example embodiments of the present disclosure and cannot be considered as limiting its scope.

FIG. 1 is a screenshot of a user interface for job searching, according to some example embodiments.

FIG. 2 is a block diagram illustrating a networked system, according to some example embodiments.

FIG. 3 is diagram illustrating search operations for a guest and a member of the online service, according to some example embodiments.

FIG. 4 illustrates the capturing of activity data for improving search results, according to some example embodiments.

FIG. 5 is a flowchart of a method for logging guest activity, according to some example embodiments.

FIG. 6 illustrates data structures for storing job and member information, according to some example embodiments.

FIG. 7 illustrates the training and use of a machine-learning program, according to some example embodiments.

FIG. 8 is a flowchart of a method, according to some example embodiments, for improving search mechanisms for guest users or unidentified members of an online service.

FIG. 9 is a block diagram illustrating an example of a machine upon or by which one or more example process embodiments described herein may be implemented or controlled.

### DETAILED DESCRIPTION

Example methods, systems, and computer programs are directed to improving search mechanisms for guest users or unidentified members of an online service. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Some search engines use information beyond the search query to help rank the results and present the searching user with the best possible results first. For example, a job-search online service may identify thousands, maybe millions, of results for a search query. The user may feel frustrated when having to deal with such a large number of possible results. The user may start adding additional parameters to the query (e.g., the name of the target company, the desired location for employment), but this is a time-consuming task and oftentimes frustrating.

In order to help the user, the job-search online service may use additional information about the user that will help sort the results according to the interest of the user. The additional information may include data from the profile of the user, previous search queries, previous activities on the online service, jobs applied to by the user, etc. Further, the job-search online service may provide to the user suggested queries, which might be built on top of the current search query, in order to narrow and better prioritize the results.

However, the job-search online service may also perform searches for members that have not registered with the online service, also referred to as guest users. Since a guest user is not registered, the online service does not have information about the guest user (e.g., job history, location, skills, education), and the job-search online service is not able to enhance the job search for the guest user without knowing anything about the guest user.

Similarly, if a registered member does not log in (referred to as an unidentified member) but still wants to perform a search, the job-search online service is in the same situation as if it were a guest user because the unidentified member has not logged in. For simplicity of description, the embodiments are presented with reference to a guest user, but the same principles apply to unidentified members.

In order to assist guest users (including unidentified members), the job-search online service logs temporarily the activities of the guest user to assist the guest user in the job search in order to better sort the job results such that the guest user is presented with the best matches at the beginning of the job results. The activities of the guest user are monitored for as long as the guest user is active on the online service and within a predetermined maximum window of time. Once the guest user is inactive for a predetermined threshold of time, the activity log is erased.

Thus, the job-search online service uses recent information for assisting the guest user. This recent information may also be used to assist registered members by identifying, in real time, trends and clues that indicate the current preferences of the member. In other implementations, the member activities are processed in batch mode (e.g., once a day) to assist in the job search. However, this approach does not allow for quick reaction by the job-search online service to adjust to the user current preferences. By using the real time information, the job-search online service can further improve the results for the register member as well.

In some example embodiments, the online service is a social network, but the same principles may be applied to other online services. Further, embodiments are presented with reference to job searches, but the same principles may be applied other query-based searches.

As the user or member enters additional queries, the online service learns about the current preferences of the user. Further, activities of the guest user, such as jobs viewed, jobs applied for, etc., allow the online service to identify the priorities of the guest user and use those priorities to assist the guest user, such as by suggesting new search queries or ranking the results based on the guest user priorities.

One general aspect includes a method that includes operations for detecting a first search query for a guest user and for initializing a session for the guest user in response to the first search query. Further, the method includes operations for logging activities of the guest user during the session and detecting a second search query on the online service for the guest user while the session is active. Results are obtained in response to the second search query, and the results are prioritized based on the second search query and the logged activities of the guest user. Further, the results are presented on a computing device of the guest user.

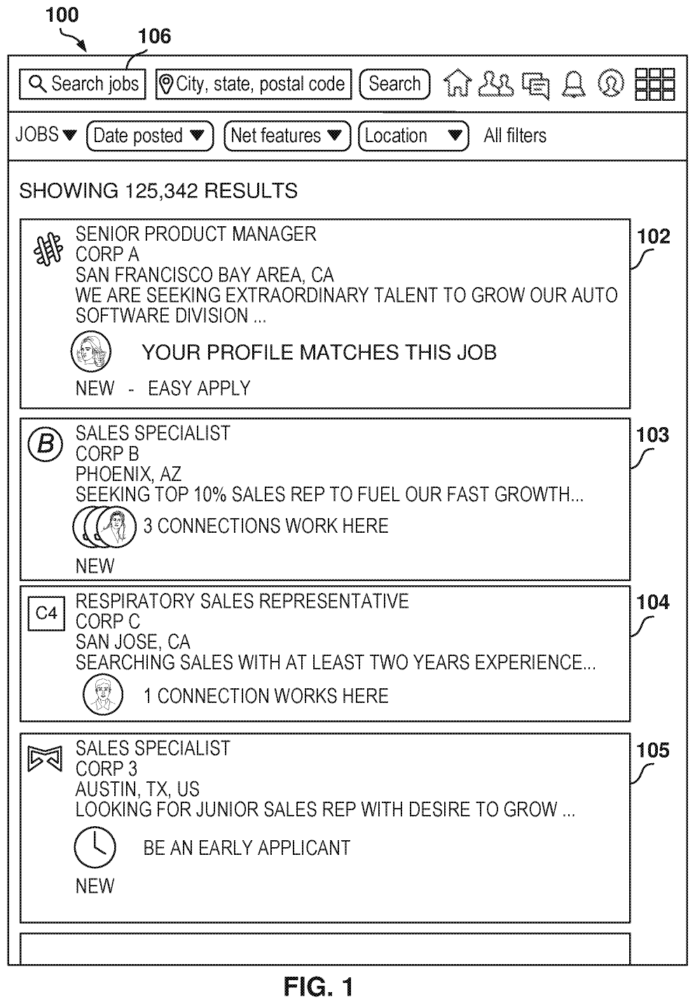

FIG. 1 is a screenshot of a user interface 100 for job searching, according to some example embodiments. In some example embodiments, the user may enter a query 106 to search for jobs and the results of the query 106 are shown in the user interface 100. In other example embodiments, the online service provides job recommendations based on the profile and activities of the user. Although some embodiments are presented with reference to responses to job-search queries, the same principles may be applied to other scenarios where job postings 102-105 are presented to the user (e.g., jobs sponsored by recruiters).

As the user scrolls down the user interface 100, more job posting recommendations are presented. In some example embodiments, the job posting recommendations are prioritized to present job postings in an estimated order of interest to the user.

Job posting 102 is for a “Senior Product Manager” at company Corp A. The job posting 102 includes summary information, such as location, all or part of the job description, and other flags, such as if the job posting 102 is new or if there is an option for “easy apply,” which means that the process for applying to the job posting 102 has been simplified by the online service.

When doing a search, the user may not necessarily enter parameters associated with the user's profile. For example, a user with experience as a software developer may perform a search for “teacher.” The job results will be related to teaching jobs, although the software developer may not have any experience as a teacher. However, if the teaching job requires software-developer experience, the software developer may see a message that indicates that the particular teaching job is a good match for his qualifications. This way, the software developer looking at changing careers may see jobs that would be a good fit.

It is noted that the embodiments illustrated in FIG. 1 are examples and do not describe every possible embodiment. Other embodiments may utilize different job-presentation layouts, including additional or less information for each job posting 102-105, etc. The embodiments illustrated in FIG. 1 should therefore not be interpreted to be exclusive or limiting, but rather illustrative.

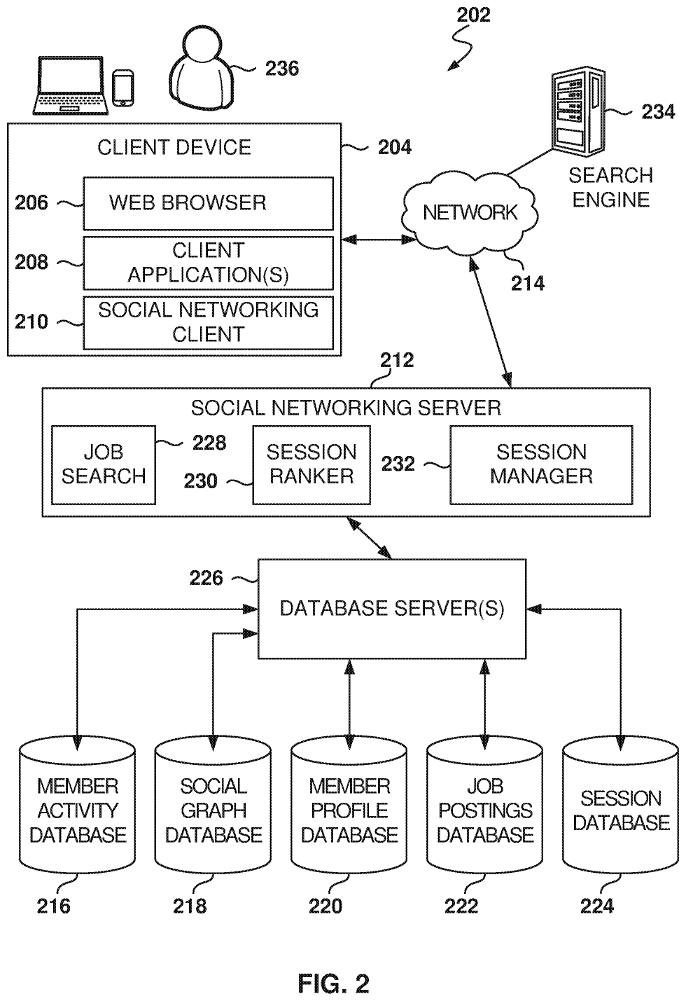

FIG. 2 is a block diagram illustrating a networked system, according to some example embodiments, including a social networking server 212, illustrating an example embodiment of a high-level client-server-based network architecture 202. Embodiments are presented with reference to an online service and, in some example embodiments, the online service is a social networking service.

The social networking server 212 provides server-side functionality via a network 214 (e.g., the Internet or a wide area network (WAN)) to one or more client devices 204. FIG. 2 illustrates, for example, a web browser 206, client application(s) 208, and a social networking client 210 executing on a client device 204. The social networking server 212 is further communicatively coupled with one or more database servers 226 that provide access to one or more databases 216-224.

The client device 204 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a member 236 may utilize to access the social networking server 212. In some embodiments, the client device 204 may comprise a display module (not shown) to display information (e.g., in the form of user interfaces). In further embodiments, the client device 204 may comprise one or more of touch screens, accelerometers, gyroscopes, cameras, microphones, Global Positioning System (GPS) devices, and so forth.

In one embodiment, the social networking server 212 is a network-based appliance that responds to initialization requests or search queries from the client device 204. One or more members 236 may be a person, a machine, or other means of interacting with the client device 204. In various embodiments, the member 236 is not part of the network architecture 202 but may interact with the network architecture 202 via the client device 204 or another means.

The client device 204 may include one or more applications (also referred to as “apps”) such as, but not limited to, the web browser 206, the social networking client 210, and other client applications 208, such as a messaging application, an electronic mail (email) application, a news application, and the like. In some embodiments, if the social networking client 210 is present in the client device 204, then the social networking client 210 is configured to locally provide the user interface for the application and to communicate with the social networking server 212, on an as-needed basis, for data and/or processing capabilities not locally available (e.g., to access a member profile, to authenticate a member 236, to identify or locate other connected members 236, etc.). Conversely, if the social networking client 210 is not included in the client device 204, the client device 204 may use the web browser 206 to access the social networking server 212.

Further, while the client-server-based network architecture 202 is described with reference to a client-server architecture, the present subject matter is of course not limited to such an architecture, and could equally well find application in a distributed, or peer-to-peer, architecture system, for example.

In addition to the client device 204, the social networking server 212 communicates with the one or more database servers 226 and databases 216-224. In one example embodiment, the social networking server 212 is communicatively coupled to a member activity database 216, a social graph database 218, a member profile database 220, a job postings database 222, and a session database 224. The databases 216-224 may be implemented as one or more types of databases including, but not limited to, a hierarchical database, a relational database, an object-oriented database, one or more flat files, or combinations thereof.

The member profile database 220 stores member profile information about members 236 who have registered with the social networking server 212. With regard to the member profile database 220, the member 236 may include an individual person or an organization, such as a company, a corporation, a nonprofit organization, an educational institution, or other such organizations.

In some example embodiments, when a member 236 initially registers to become a member 236 of the social networking service provided by the social networking server 212, the member 236 is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 220. Similarly, when a representative of an organization initially registers the organization with the social networking service provided by the social networking server 212, the representative may be prompted to provide certain information about the organization, such as a company industry. This information may be stored, for example, in the member profile database 220.

As members 236 interact with the social networking service provided by the social networking server 212, the social networking server 212 is configured to monitor these interactions. Examples of interactions include, but are not limited to, commenting on posts entered by other members 236, viewing member profiles, editing or viewing a member 236's own profile, sharing content outside of the social networking service (e.g., an article provided by an entity other than the social networking server 212), updating a current status, posting content for other members 236 to view and comment on, posting job suggestions for the members 236, searching job postings, and other such interactions. In one embodiment, records of these interactions are stored in the member activity database 216, which associates interactions made by a member 236 with his or her member profile stored in the member profile database 220.

The job postings database 222 includes job postings offered by companies. Each job posting includes job-related information such as any combination of employer, job title, job description, requirements for the job posting, salary and benefits, geographic location, one or more job skills desired, day the job posting was posted, relocation benefits, and the like.

The session database 224 includes data obtained in a user's session. A session refers to a period of time where the user is active on the online service. The session ends after the user is inactive for a predetermined amount of time, such as four hours. In some example embodiments, the predetermined amount of time is in the range from fifteen minutes to 24 hours, but other embodiments may use other predetermined amounts of time for determining when the session ends.

In some example embodiments, the session data, stored in the session database 224, includes a log of user activities, such as the data stored in member activity database 216. However, in some example embodiments, the session data, for a session that expires, is deleted after the end of the session. In other example embodiments, some of the data from the session database 224 may also be transferred to the member activity database 216. For example, the session database 224 may include clicks entered by the user (e.g., jobs or websites selected by the user), jobs viewed, search queries, job applications submitted, session timers, and identification of the user (e.g., browser identifier).

While the database server(s)226 are illustrated as a single block, one of ordinary skill in the art will recognize that the database server(s) 226 may include one or more such servers. Accordingly, and in one embodiment, the database server(s) 226 implemented by the social networking service are further configured to communicate with the social networking server 212.

The social networking server 212 includes, among other modules, a job search module 228, a session ranker 230, and a session manager 232. More details regarding the functionality of these modules is provided below. Each of the modules may be implemented in software, hardware, or any combination of software and hardware.

The network architecture 202 may also include a search engine 234. Although only one search engine 234 is depicted, the network architecture 202 may include multiple search engines 234. Thus, the social networking server 212 may retrieve search results (and, potentially, other data) from multiple search engines 234. The search engine 234 may be a third-party search engine. Examples of the search engine 234 include Bing, Ask, and search engines provided by Google, Yahoo!, Baidu, and AOL.

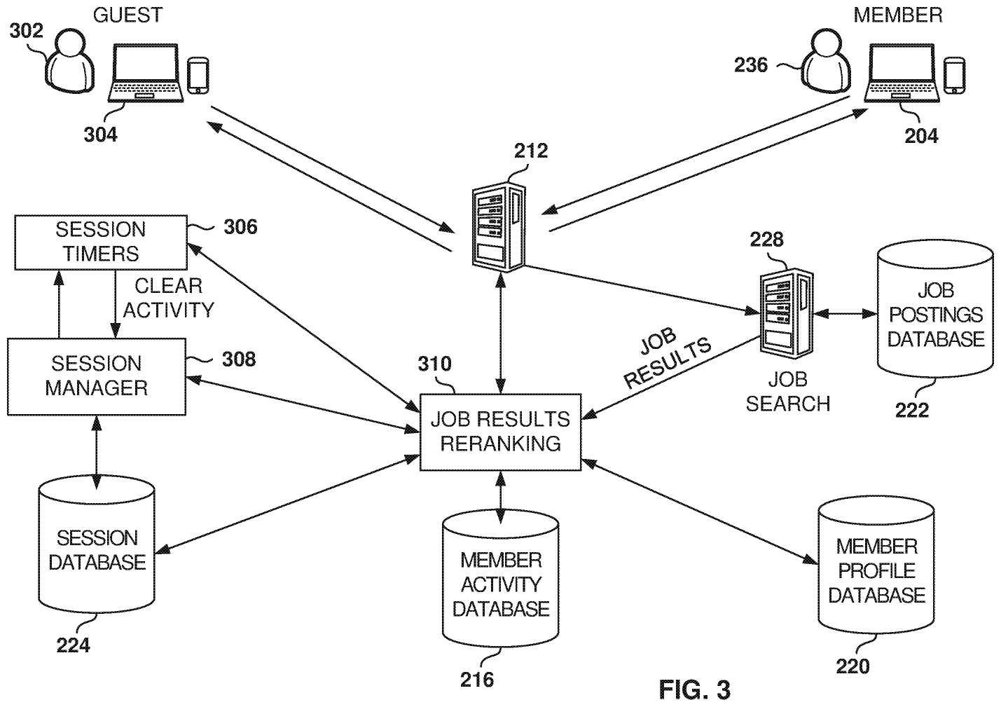

FIG. 3 is diagram illustrating search operations for a guest user and a member of the online service, according to some example embodiments. The guest user 302, using computing device 304, submits a job-search query to the social networking server 212. In some cases, 5% to 6% of search queries are performed by guest users, although the percentages may vary.

The social networking server 212 since the query to the job-search module 228, which performs the job search from the job postings database 222. The job results, sorted by relevance, are transferred to the job results reranking module 310.

The job results reranking module 310 analyzes guests user or member profile and activity data to re-prioritize the job results based on activities of the user. For example, the reranking may account for the recent job views selected by the user to narrow the jobs that are more interesting to the user based on recent activity. For example, if an attorney is looking for a job, there may be millions of job openings for attorneys on the social network, but there are many types of law that attorneys may practice. By looking at the activity of the attorney, the job search will prioritize attorney jobs based on the practice area of the attorney, such as corporate jobs for corporate attorneys, intellectual-property jobs for patent attorneys, etc.

Additionally, for the registered member 236, the job results reranking may use member profile information (e.g., title, skill, job experience, education, etc.) to prioritize the job results. In some example embodiments, the job-search module 228 may also use the member profile information as well as the member activity information.

It is noted that session information may also be used for the registered member 236 in order to consider recent activities (e.g., jobs viewed, jobs applied to) of the registered member 236 since the member activity database 216 and member profile database 220 may not be updated as frequently as the session information.

Additionally, if little information is available for a registered member 236, the session data is helpful to assist the registered member 236. For example, if the registered member 236 has registered recently and has not entered profile information, there is not much information that can be derived from the profile of member activity. If suddenly the registered member 236 starts searching for a job, the session data will assist when the member information is lacking.

Job searching is typically an activity performed during certain periods, but not during others. This means that the user may become active in job searching and then stop searching for jobs for six months, a year, or more. If the member has not been active in searching for jobs for a period of time (e.g., six months), the previously registered activities regarding job searching may be obsolete. Therefore, focusing on the recent session activity will produce better results for the user because it is focused on the user's current search parameters and activities related to job searching.

The session manager 308 coordinates all session activities, such as creating a new session for the guest user 302, updating session timers 306, and storing session data in the session database 224. In some example embodiments, the guest user 302 is identified by the browser identifier of the browser in the computing device 304 used to access the social network. In some example embodiments, a cookie in the browser may also be used to identify the user or log some activities.

For example, if a guest user is searching for attorney jobs, the session activity may show that the attorney is looking at tax attorney job openings. As this information is captured, future job searches will prioritize tax attorney job openings above other types of attorney job openings.

Therefore, the guest user activity is logged while the guest user 302 is actively searching within a session. The session data is typically stored for periods of hours, not days or months. In the guest user 302 returns after a month, the session is restarted with no historical information.

The session timers are updated each time the guest user 302 interacts with the social network. The session timer expires when a predetermined amount of time elapses without user activity on the social network. In response to the expiration of the timer, the session is terminated, which includes clearing all information regarding the activity of the guest user 302 and erasing the session from the session database 224.

In some example embodiments, the job-search module 228 utilizes a machine-learning model for understanding the context of the user. In some cases, the machine-learning model is trained using off-line pipelines every 12 to 24 hours. However, guest users cannot benefit from these off-line models, so the session data is used to improve the job searching of the guest users 302.

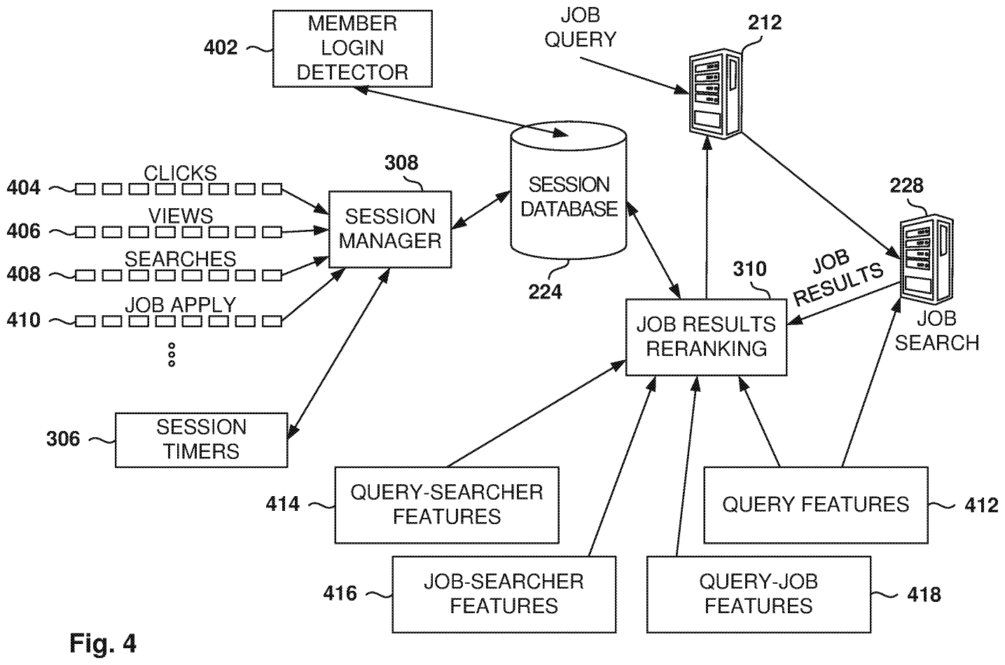

FIG. 4 illustrates the capturing of activity data for improving search results, according to some example embodiments. Any type of user activity may be captured during the session and stored in the session database 224. In some example embodiments, the user activity (also referred to as activity stream) is saved as events that include one or more of clicks 404 (e.g., jobs or web links selected by the user), views 406 (e.g., jobs or webpages viewed by the user), search queries 408 of the user, jobs applied 410 to by the user, jobs saved, job alerts, articles viewed, companies followed, location, etc.

In some example embodiments, the sessions are indexed by browser identifier (ID); that is, each session is identified by the browser ID. In our example embodiments, a browser cookie is used as the identifier for sessions, and the cookie is referred to as the activity cookie. The session data is then assigned by activity cookie. When a new session is a started, the activity cookie is created and the session is indexed by the activity cookie.

The session information helps to prioritize jobs. For example, if the user is applying for jobs at one or two companies, the job results will prioritize jobs offered by the one or two companies and present those to the user first. If the user tends to view jobs in small companies, small-company jobs will be prioritized. The online service learns about the user based on the user's activity.

A user may start searching for a type of job, but the user activity may show that the user is switching interest or narrowing the field of search. The session data allows the online service to detect these changes and assist the user based on the new activity trends. For example, a software engineer may do a search for software engineer artificial intelligence (AI), but the software engineer starts selecting jobs in deep learning (which is a part of AI). The online service will realize the preference of the software engineer and start prioritizing deep-learning job openings.

Sometimes, the user may not have a clear idea of how to search for the right job. If the online service only focuses on the search queries, the online service may not adequately assist the user in navigating thousands or millions of job openings. But by using additional information besides the search queries themselves (e.g., jobs viewed), the online service is able to help the user and get to the desired jobs faster. This improves user satisfaction and user retention, because the user does not get frustrated with the job search, which may cause the user to quit the search.

With reference to job clicks 404, once the guest user begins searching at the online service webpage, the guest user is presented jobs in the jobs result page, as the one illustrated in FIG. 1. The online service then logs events corresponding to the job clicks 404 of the user.

Further, the job view 406 occurs after a job is clicked and the guest user views the clicked job. A job apply 410 happens after a user views a job and sends a job application for the same.

Once a member views a job search result, the member may save the job if the member likes the job search result. Further, the member may register to receive alerts related to the saved job or other jobs that are significant to the user.

In some example embodiments, the events of a session are saved in a Session Row, which includes a row identifier ((D), events in the session MemberLastSessionActivityDetail (array of actions or events), creation time stamp CreatedTs (time when record was created), and update time stamp UpdatedTs (time when record was updated).

Sometimes, a registered user does not log in and is considered a guest user. Later on, the registered user may log in, and then the session data for the user is erased or may be transferred to the activity data kept for registered users. The member login detector module 402 monitors when users that initiated sessions as guest users log in. The member login detector module 402, once a login is detected, will erase the session data or transfer to the activity data for registered users.

In some example embodiments, a schema definition includes the following:

Id: MemberId or GuestId //can be prepended if they are not mutually exclusive MemberLastSessionActivityDetail:

```
Array of Action:
  action (String), //e.g. view, apply, jobSearch
  jobId (Long or Null), //Null for jobSearch, jobId for view/apply
  timeStamp(Long), //timeStamp of this action
  additionalInfo (Array, {“key”:“string”, “value”:“string”})
    //e.g. jobSearch parameters for jobSearch
```

### CreatedTs: Long

### UpdatedTs: Long

Below is an example event stored in a Session Row:

```
{
“id”: 123, // memberId or guestid, assuming the two don't overlap;
if they do, we
          can prepend by ‘m:’ or ‘g:’
“MemberLastSessionActivityDetail” : {
  “array” : [ {
      “actionType” : “JOB_SEARCH”,
      “actionTimeStamp” : 1531714357222,
      “jobId” : null,
      “additional:Info” : [ {
        “key” : “keyword”,
        “value” : “chief medical officer”
      }, {
        “key” : “a:placeLocation.entityType”,
        “value” : “COUNTRY”
      }, {
        “key” : “a:distance”,
        “value” : “25.0”
      }, {
        “key” : “a:placeLocation.entityCode”,
        “value” : “0”
      }, {
        “key” : “a:countryCode”,
        “value” : “us”
      }, {
        “key” : “a:placeLocation.countryCode”,
        “value” : “us”
      }, {
        “key” : “numRes”,
        “value” : “6470” // Returned jobs count for this search query
      } ]
      }, {
        “actionType” : “JOB_DETAILS”,
        “actionTimeStamp” : 1531714357310,
        “jobId” : {
          “long” : 724737493
        },
        “additionalInfo” : [ ]
      } ]
},
  },
  “CreatedTs” : 123, // record creation ts, first time activity
  “UpdatedTs” : 123, // record update ts, last timestamp activity
  of this member
}
```

Since this is the result of a search, there is no job ID because it is not a job view. The user searched for chief medical officer, and additional metadata is included, such as the country where the user resides and the distance to the job location. Further, the second element includes details about the job that the user viewed, including the job ID and the action timestamp.

Each time the user has a new activity for the session, a check is made to determine if the session has expired (e.g., the last update was less than four hours ago). If the session has not expired, the new activity is appended to the current activity list (e.g., activity array). If the session has expired, the session data is purged and a new session is initiated with the new activity.

In some example embodiments, the session database 224 stores the data for each session in one row of a table. When a new event is received for the session, an upsert operation is performed to add the new event. An upsert operation inserts a new row in the table if the row for the session does not exists, or updates the existing row for the session if the row for the session already exists.

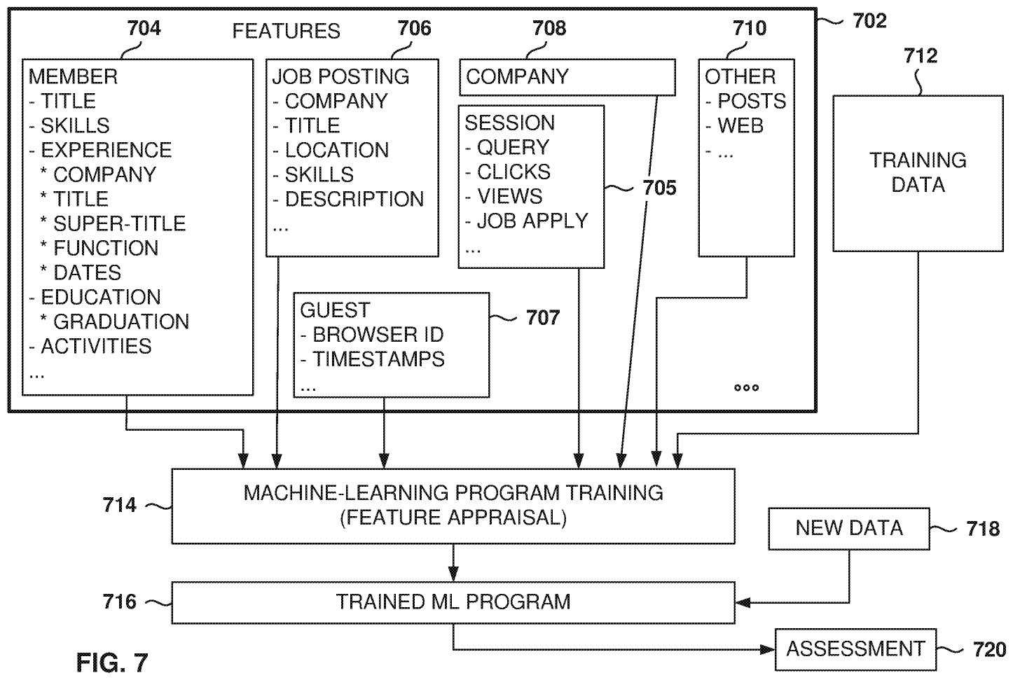

In some example embodiments, the job results reranking module 310 includes a machine-learning model that utilizes the session data in the session database 224. The session data is one of the features of the machine-learning model, and the session features are given higher weights for job reranking than other data, such as member activity data from the day before or earlier. More details about the machine-learning model are provided below with reference to FIG. 7.

Having the session organized by row simplifies the operations for training the machine-learning model and using the data for making predictions (e.g., providing a ranking score for a job).

The session manager 308 includes a variety of messaging queues for the incoming events, and the job results reranking module 310 consumes these events for job reranking.

As described above, performing a search for jobs involves two phases, in some example embodiments. In the first phase, the job search module 228 does the job search based on the search query, and in the second phase, the job results reranking module 310 reorders the job results based on several features, which include the session data.

The job results reranking module 310 gets the job results from the job search module 228 and assigns a ranking score to each of the job results. The ranking score is then used to reorder the job results before the job results are presented to the guest user.

There are four types of features: query features 412, query-searcher features 414, job-searcher features 416, and query-job features 418. The query features 412 are those identified by the query, such as the words entered in a query. The query features 412 describe the desired characteristics of the searched job posting and are used by the job search module 228 and the job results reranking module 310 to find jobs that match the query.

For example, the query features 412 may include “software engineer” and the search will include jobs for software engineers as described in the tile or in the description of the job. Thus, if the online services does not have information about the user, the query features 412 are the features that will be used for searching for job postings.

The query-searcher features 414 are features corresponding to the relationship between the user searching (e.g., the searcher) and the query. For example, the query-searcher features 414 include previous searches by the user, previous jobs applied, previous job viewed, etc. That is, the query-searcher features 414 describe the activity history of the user. For example, if the user was presented with jobs from company A and company B in response to a search query, and the user consistently selected to view the jobs from company B, the job results reranking module 310 will give higher priority to the jobs from company B in future searches.

The job-searcher features 416 are features corresponding to the relationship between the user searching (e.g., the searcher) and the job posting. For example, if a user has a skill as a “Mexican-food cook,” jobs for Mexican-food cooks will be given a higher score.

The query-job features 418 are features corresponding to the relationship between the query and the job posting.

It is noted that the embodiments illustrated in FIG. 4 are examples and do not describe every possible embodiment. Other embodiments may utilize different modules, combine functionality of multiple modules, keep track of additional or fewer events, etc. The embodiments illustrated in FIG. 4 should therefore not be interpreted to be exclusive or limiting, but rather illustrative.

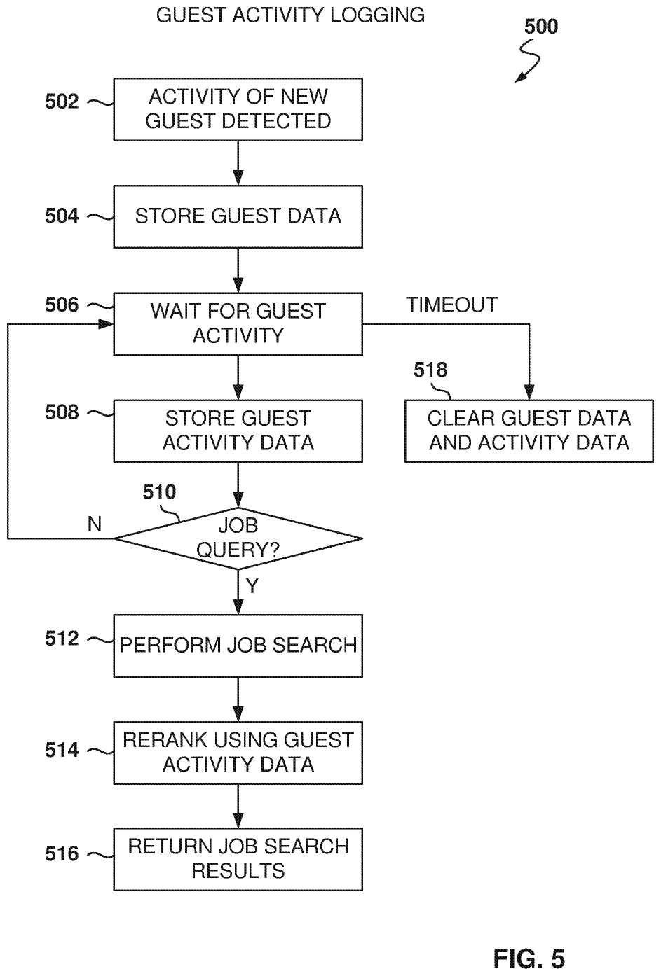

FIG. 5 is a flowchart of a method 500 for logging guest activity, according to some example embodiments. While the various operations in this flowchart are presented and described sequentially, one of ordinary skill will appreciate that some or all of the operations may be executed in a different order, be combined or omitted, or be executed in parallel.

At operation 502, activity of a new guest user is detected on the online service. From operation 502, the method 500 flows to operation 504 where the guest user data, associated with the new activity, is stored (e.g., in session database 224).

From operation 504, the method 500 flows to operation 506 where the online service waits for new activity from the guest user. If a timeout occurs while waiting at operation 506, the method 500 flows to operation 518. The timeout indicates that the guest user has been inactive for a threshold amount of time (e.g., four hours, but other threshold amounts of time are possible).

If new guest user activity is detected at operation 506, the method 500 flows to operation 508 where the guest user activity data is stored. From operation 508, the method 500 flows to operation 510, where a check is made to determine if the activity detected at operation 506 corresponds to a new job query. If the new activity is not for a job query, the method 500 flows to operation 506 to wait for additional guest user activities. If the new activity is for a job query, the method 500 flows to operation 512 where a job search is performed (e.g., as described above with reference to FIG. 3).

At operation 514, the results from the job search are reranked using the guest activity data previously collected. From operation 514, the method 500 flows to operation 516 where the results of the job search are returned to the user.

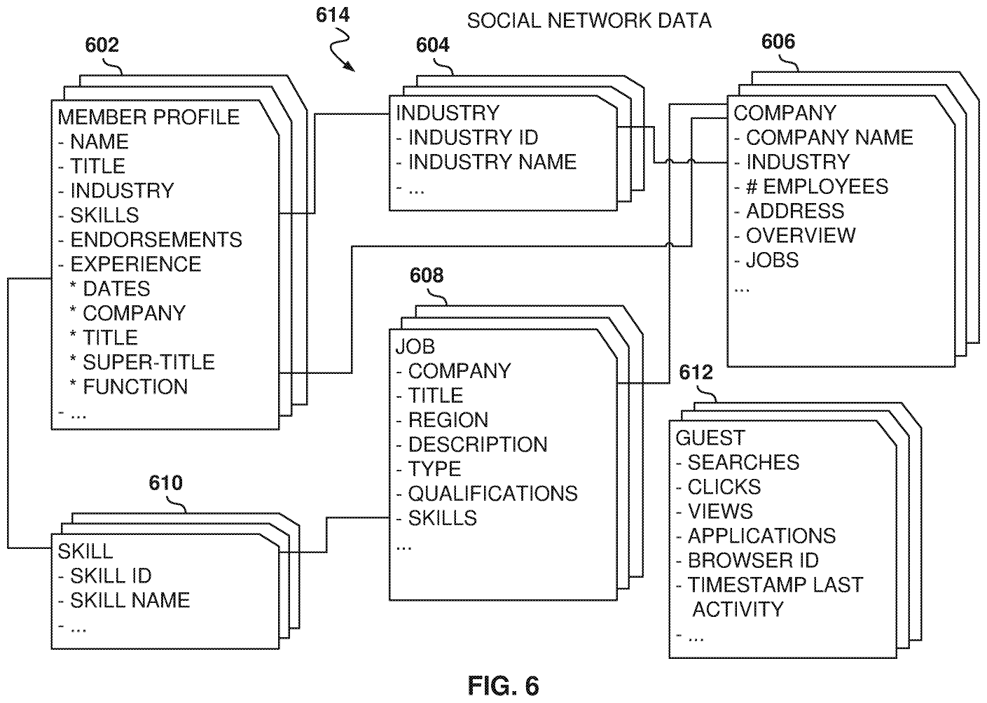

FIG. 6 illustrates data structures for storing social network data 614, according to some example embodiments. Each user in the social network has a member profile 602, which includes information about the user. The member profile 602 is configurable by the user and includes information about the user and about user activity in the social network (e.g., items liked, posts read).

In one example embodiment, the member profile 602 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 602 includes member information, such as name, title (e.g., job title), industry (e.g., legal services), geographic region, jobs, skills and endorsements, and so forth. In some example embodiments, the member profile 602 also includes job-related data, such as employment history, jobs previously applied to, or jobs already suggested to the member (and how many times the job has been suggested to the member). The experience information includes information related to the professional experience of the user, and may include, for each job, dates, company, title, super-title, functional area, industry, etc. Within member profile 602, the skill information is linked to skill data 610, the employer information is linked to company data 606, and the industry information is linked to industry data 604. Other links between tables may be possible.

The skill data 610 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 604 is a table for storing the industries identified in the social network. In one example embodiment, the industry data 604 includes an industry identifier (e.g., a numerical value or a text string), and an industry name, which is a text string associated with the industry (e.g., legal services).

In one example embodiment, the company data 606 includes company information, such as company name, industry associated with the company, number of employees, address, overview description of the company, job postings, and the like. In some example embodiments, the industry is linked to the industry data 604.

The skill data 610 is a table for storing the different skills identified in the social network. In one example embodiment, the skill data 610 includes a skill identifier (ID) (e.g., a numerical value or a text string) and a name for the skill. The skill identifier may be linked to the member profile 602 and job data 608.

In one example embodiment, job data 608 includes data for jobs posted by companies in the social network. The job data 608 includes one or more of a title associated with the job (e.g., software developer), a company that posted the job, a geographic region for the job, a description of the job, job type (e.g., full time, part time), qualifications required for the job, and one or more skills. The job data 608 may be linked to the company data 606 and the skill data 610.

In some embodiments, the social network imports jobs from other websites, such as the jobs page of the company, and those job postings may include an employment status (e.g., part-time, in-house). This information may also be used as features for the machine-learning model.

Additionally, some members may enter salary data in their profiles, and the salary data may be entered as hourly or salaried. This signal may also be used as a feature for the machine-learning model.

The guest data 612 includes information about a guest user and includes one or more of searches entered by the guest user, clicks, job views, job applications submitted, browser ID (or cookie ID), timestamp for the last activity, timestamp for when the session was started, etc.

The social network data 614 may be combined to assist in the search. For example, features and other job metadata may be extracted from a given job post, such as seniority required for the job (e.g., from apprentice to senior or master). As the guest user views different job openings, an inference may be made that the guest user is searching for entry-level jobs when the guest user tends to only view entry-level jobs. Therefore, the seniority of the guest user may be inferred based on the view patterns, and the job search will give higher priority to entry-level job posts for presentation to the guest user.

It is noted that the embodiments illustrated in FIG. 6 are examples and do not describe every possible embodiment. Other embodiments may utilize different data structures, fewer data structures, combine the information from two data structures into one, add additional or fewer links among the data structures, and the like. The embodiments illustrated in FIG. 6 should therefore not be interpreted to be exclusive or limiting, but rather illustrative.

FIG. 7 illustrates the training and use of a machine-learning program, according to some example embodiments. In some example embodiments, machine-learning programs (MLP), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 712 in order to make data-driven predictions or decisions expressed as outputs or assessments 720. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), deep neural networks (DNN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms utilize the training data 712 to find correlations among identified features 702 that affect the outcome.

The machine-learning algorithms utilize features for analyzing the data to generate assessments 720. A feature 702 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, the features 702 may be of different types and may include one or more of member 704, session features 705, job features 706, guest user features 707, company features 708 and other features 710 (user posts, web activity, followed companies, etc.). The features 702 may include all or part of the social network data 614, as described above with reference to FIG. 6. The data sources include member standardized data, jobs standardized data, member connections, member employment preferences, job views, job applied, job information, salary information, etc.

The machine-learning algorithms utilize the training data 712 to find correlations among the identified features 702 that affect the outcome or assessment 720. In some example embodiments, the training data 712 includes known data for one or more identified features 702 and one or more outcomes, such as the employment type (field or full-time-corporate).

With the training data 712 and the identified features 702, the machine-learning tool is trained at operation 714. The machine-learning tool appraises the value of the features 702 as they correlate to the training data 712. The result of the training is the trained machine-learning program 716.

When the machine-learning program 716 is used to perform an assessment, new data 718 is provided as an input to the trained machine-learning program 716, and the machine-learning program 716 generates the assessment 720 as output. For example, the machine-learning program may be used to provide a ranking score for a job post, and the ranking score may be used to sort the data results before presentation to the user.

In some example embodiments, part of the data (e.g., 90%) is used to train the machine-learning program and the rest is reserved for testing and validation. In some example embodiments, the model output is evaluated sampling results and manually validating these results. The results may be evaluated by human judges or may be evaluated by asking members of the social network directly to confirm the validity of the predictions, or by asking the employers to confirm the predictions for the given title or titles. By evaluating the sample results, it is possible to determine the accuracy of the predictions by the model.

In some example embodiments, the training data 712 may include previous activities from guest users and the job posts that the guest users selected for viewing, as well as the job posts that the guest users ignored.

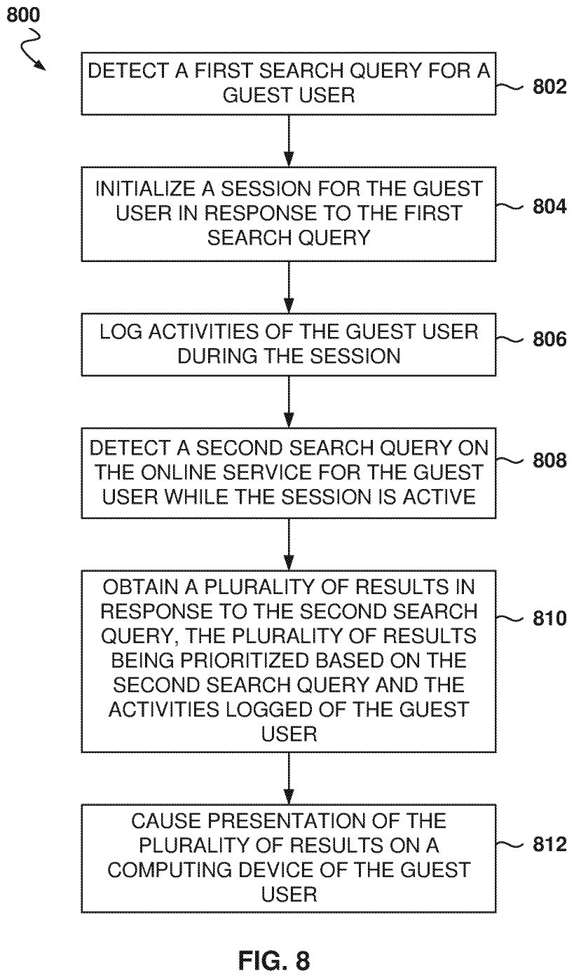

FIG. 8 is a flowchart of a method 800, according to some example embodiments, for improving search mechanisms for guest users or unidentified members of an online service. While the various operations in this flowchart are presented and described sequentially, one of ordinary skill will appreciate that some or all of the operations may be executed in a different order, be combined or omitted, or be executed in parallel.

At operation 802, one or more processors of an online service detect a first search query for a guest user. From operation 802, the method 800 flows to operation 804 for initializing, by the one or more processors, a session for the guest user in response to the first search query.

From operation 804, the method 800 flows to operation 806 where the one or more processors log activities of the guest user during the session. From operation 806, the method 800 flows to operation 808 for detecting, by the one or more processors, a second search query on the online service for the guest user while the session is active.

From operation 808, the method 800 flows to operation 810 where the one or more processors obtain a plurality of results in response to the second search query. The plurality of results are prioritized based on the second search query and the activities logged of the guest user.

From operation 810, the method 800 flows to operation 812 where the one or more processors cause presentation of the plurality of results on a computing device of the guest user.

In one example, the guest user is a user not registered in the online service or a user that is registered in the online service and is not logged into the online service.

In one example, obtaining the plurality of results further includes performing a search based on the second search query to generate a first set of results, and reranking the first set of results based on the activities logged during the session.

In one example, reranking the first set of results is performed by a machine-learning model trained with data captured during previous sessions of users on the online service.

In one example, the machine-learning model includes features associated with the activities logged during the session.

In one example, the method 800 further comprises ending the session after a predetermined amount of time without any activity in the online service by the guest user, and deleting the activities logged after ending the session.

In one example, the first search query and the second search query are searches for job postings.

In one example, the activities include one or more of clicks on results provided by the online service, results viewed by the guest user after searching in the online service, search queries submitted by the guest user, and jobs applied to by the guest user.

In one example, the method 800 further comprises detecting a login into the online service by the guest user, and deleting the activities logged or transferring the activities logged to a database storing activities of members of the online service.

In one example, obtaining the plurality of results further includes prioritizing results, for presentation to the guest user, having characteristics similar to results selected by the guest user after previous searches.

Another general aspect is for a system that includes a memory comprising instructions and one or more computer processors. The instructions, when executed by the one or more processors of an online service, cause the one or more computer processors to perform operations comprising: detecting, by the one or more processors, a first search query for a guest user; initializing, by the one or more processors, a session for the guest user in response to the first search query; logging, by the one or more processors, activities of the guest user during the session; detecting, by the one or more processors, a second search query on the online service for the guest user while the session is active; obtaining, by the one or more processors, a plurality of results in response to the second search query, the plurality of results being prioritized based on the second search query and the activities logged of the guest user; and causing, by the one or more processors, presentation of the plurality of results on a computing device of the guest user.

In yet another general aspect, a machine-readable storage medium (e.g., a non-transitory storage medium) includes instructions that, when executed by a machine, cause the machine to perform operations comprising: detecting, by the one or more processors, a first search query for a guest user; initializing, by the one or more processors, a session for the guest user in response to the first search query; logging, by the one or more processors, activities of the guest user during the session; detecting, by the one or more processors, a second search query on the online service for the guest user while the session is active; obtaining, by the one or more processors, a plurality of results in response to the second search query, the plurality of results being prioritized based on the second search query and the activities logged of the guest user; and causing, by the one or more processors, presentation of the plurality of results on a computing device of the guest user.

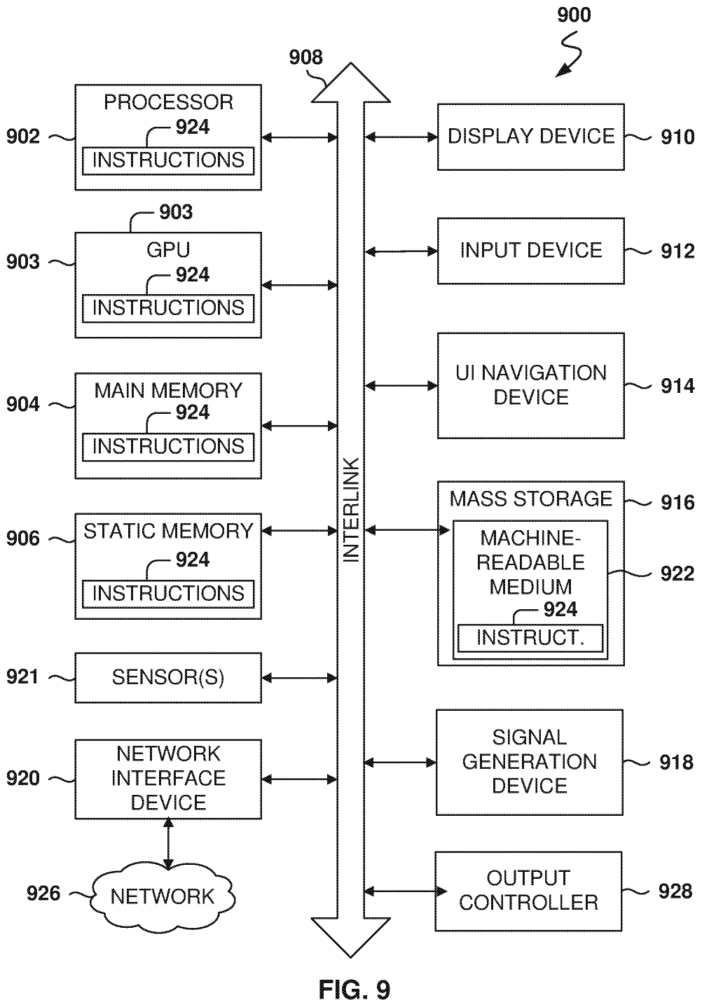

FIG. 9 is a block diagram illustrating an example of a machine 900 upon or by which one or more example process embodiments described herein may be implemented or controlled. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in a peer-to-peer (P2P) (or other distributed) network environment. Further, while only a single machine 900 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 900 may include a hardware processor 902 (e.g., a central processing unit (CPU), a hardware processor core, or any combination thereof), a graphics processing unit (GPU) 903, a main memory 904, and a static memory 906, some or all of which may communicate with each other via an interlink (e.g., bus) 908. The machine 900 may further include a display device 910, an alphanumeric input device 912 (e.g., a keyboard), and a user interface (UI) navigation device 914 (e.g., a mouse). In an example, the display device 910, alphanumeric input device 912, and UI navigation device 914 may be a touch screen display. The machine 900 may additionally include a mass storage device (e.g., drive unit) 916, a signal generation device 918 (e.g., a speaker), a network interface device 920, and one or more sensors 921, such as a Global Positioning System (GPS) sensor, compass, accelerometer, or another sensor. The machine 900 may include an output controller 928, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 916 may include a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, within the hardware processor 902, or within the GPU 903 during execution thereof by the machine 900. In an example, one or any combination of the hardware processor 902, the GPU 903, the main memory 904, the static memory 906, or the mass storage device 916 may constitute machine-readable media.

While the machine-readable medium 922 is illustrated as a single medium, the term “machine-readable medium” may include a single medium, or multiple media, (e.g., a centralized or distributed database, and/or associated caches and servers) configured to store the one or more instructions 924.

The term “machine-readable medium” may include any medium that is capable of storing, encoding, or carrying instructions 924 for execution by the machine 900 and that cause the machine 900 to perform any one or more of the techniques of the present disclosure, or that is capable of storing, encoding, or carrying data structures used by or associated with such instructions 924. Non-limiting machine-readable medium examples may include solid-state memories, and optical and magnetic media. In an example, a massed machine-readable medium comprises a machine-readable medium 922 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device 920.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
detecting, by one or more processors of an online service, a first search query for a guest user;
initializing, by the one or more processors, a session for the guest user in response to the first search query;
logging, by the one or more processors, activities of the guest user during the session;
detecting, by the one or more processors, a second search query on the online service for the guest user while the session is active;
obtaining, by the one or more processors, a plurality of results in response to the second search query, the plurality of results being prioritized based on the second search query and the activities logged of the guest user; and
causing, by the one or more processors, presentation of the plurality of results on a computing device of the guest user.

2. The method as recited in claim 1, wherein the guest user is a user not registered in the online service or a user that is registered in the online service and is not logged into the online service.

3. The method as recited in claim 1, wherein obtaining the plurality of results further includes:
performing a search based on the second search query to generate a first set of results; and
reranking the first set of results based on the activities logged during the session.

4. The method as recited in claim 3, wherein reranking the first set of results is performed by a machine-learning model trained with data captured during previous sessions of users on the online service.

5. The method as recited in claim 4, wherein the machine-learning model includes features associated with the activities logged during the session.

6. The method as recited in claim 1, further comprising:
ending the session after a predetermined amount of time without any activity in the online service by the guest user; and
deleting the activities logged after ending the session.

7. The method as recited in claim 1, wherein the first search query and the second search query are searches for job postings.

8. The method as recited in claim 1, wherein the activities include one or more of clicks on results provided by the online service, results viewed by the guest user after searching in the online service, search queries submitted by the guest user, and jobs applied to by the guest user.

9. The method as recited in claim 1, further comprising:
detecting a login into the online service by the guest user; and
deleting the activities logged or transferring the activities logged to a database storing activities of members of the online service.

10. The method as recited in claim 1, wherein obtaining the plurality of results further includes:
prioritizing results, for presentation to the guest user, having characteristics similar to results selected by the guest user after previous searches.

11. A system comprising:
a memory comprising instructions; and
one or more processors of an online service, wherein the instructions, when executed by the one or more processors, cause the system to perform operations comprising:
detecting, by the one or more processors, a first search query for a guest user;
initializing, by the one or more processors, a session for the guest user in response to the first search query;
logging, by the one or more processors, activities of the guest user during the session;
detecting, by the one or more processors, a second search query on the online service for the guest user while the session is active;
obtaining, by the one or more processors, a plurality of results in response to the second search query, the plurality of results being prioritized based on the second search query and the activities logged of the guest user; and
causing, by the one or more processors, presentation of the plurality of results on a computing device of the guest user.

12. The system as recited in claim 11, wherein the guest user is a user not registered in the online service or a user that is registered in the online service and is not logged into the online service.

13. The system as recited in claim 11, wherein obtaining the plurality of results further includes:
performing a search based on the second search query to generate a first set of results; and
reranking the first set of results based on the activities logged during the session.

14. The system as recited in claim 13, wherein reranking the first set of results is performed by a machine-learning model trained with data captured during previous sessions of users on the online service, wherein the machine-learning model includes features associated with the activities logged for the session.

15. The system as recited in claim 11, wherein the instructions further cause the one or more processors to perform operations comprising:
ending the session after a predetermined amount of time without any activity in the online service by the guest user; and
deleting the activities logged after ending the session.

16. A non-transitory machine-readable storage medium including instructions that, when executed by a machine, cause the machine to perform operations comprising:
detecting, by one or more processors of an online service, a first search query for a guest user;
initializing, by the one or more processors, a session for the guest user in response to the first search query;
logging, by the one or more processors, activities of the guest user during the session;
detecting, by the one or more processors, a second search query on the online service for the guest user while the session is active;
obtaining, by the one or more processors, a plurality of results in response to the second search query, the plurality of results being prioritized based on the second search query and the activities logged of the guest user; and
causing, by the one or more processors, presentation of the plurality of results on a computing device of the guest user.

17. The non-transitory machine-readable storage medium as recited in claim 16, wherein the guest user is a user not registered in the online service or a user that is registered in the online service and is not logged into the online service.

18. The non-transitory machine-readable storage medium as recited in claim 16, wherein obtaining the plurality of results further includes:
performing a search based on the second search query to generate a first set of results; and
reranking the first set of results based on the activities logged during the session.

19. The non-transitory machine-readable storage medium as recited in claim 18, wherein reranking the first set of results is performed by a machine-learning model trained with data captured during previous sessions of users on the online service, wherein the machine-learning model includes features associated with the activities logged for the session.

20. The non-transitory machine-readable storage medium as recited in claim 16, wherein the machine further performs operations comprising:
ending the session after a predetermined amount of time without any activity in the online service by the guest user; and
deleting the activities logged after ending the session.
